(19) United States
(12) Patent Application Publication
(10) Pub. No.: US 2013/0318513 A1
(43) Pub. Date: Nov. 28, 2013

(54) APPARATUS FOR UPDATING FIRMWARE OR PARAMETERS AND THE COMPUTER USING THE SAME

(71) Applicants: Kung-Hsien Chu, Hsinchu (TW); Pi-Chiang Lin, Hsinchu (TW)

(72) Inventors: Kung-Hsien Chu, Hsinchu (TW); Pi-Chiang Lin, Hsinchu (TW)

(21) Appl. No.: 13/889,375

(22) Filed: May 8, 2013

(30) Foreign Application Priority Data
May 23, 2012 (TW) 101209750

(51) Int. Cl. G06F 9/445

(52) U.S. Cl. CPC G06F 8/665
USPC 717/168

(57) ABSTRACT

An apparatus for updating firmware or parameters is disclosed. The apparatus is disposed in a computer system and electrically coupled to a platform controller hub (PCH) chipset having a first USB host interface and a nonvolatile memory. The apparatus comprises: a second USB host interface; a switch element, electrically coupled to the first USB host interface, the second USB host interface and a USB device, wherein the switch element electrically couples the USB device to either the first USB host interface or the second USB host interface; and a control element, electrically coupled to the second USB host interface and the switch element, wherein when the computer system is not powered on normally, the control element controls the switch element to electrically couple the USB device to the second USB host interface, wherein the control element fetches a firmware or parameters stored in the USB device and updates the nonvolatile memory with the fetched firmware or the parameters.

### CROSS REFERENCE TO RELATED APPLICATIONS

This application claims the priority benefit of Taiwan application serial no. 101209750, filed on May 23, 2012. The entirety of the above-mentioned patent application is hereby incorporated by reference herein and made a part of specification.

### BACKGROUND OF THE INVENTION

I. Field of the Invention

The present invention relates to an apparatus for updating firmware or parameters, and in particular to an apparatus for updating firmware or parameters when a failure occurs during powering on a computer.

II. Description of the Prior Art

A desktop computer or a notebook has a nonvolatile memory to store a basic input/output system (BIOS). When powering on a desktop computer or a notebook, the basic input/output system (BIOS) initializes the configurations of chipsets and memory devices in the computer. Generally, the basic input/output system (BIOS) is electrically coupled to a peer chip, such as a south bridge chip, a platform controller hub (PCH) chipset, an embedded controller (EC) or a super I/O (SIO) chip, as illustrated in FIG. 1A and FIG. 1B.

Please refer to FIG. 1A which illustrates a conventional computer framework 1000 in which a basic input/output system (BIOS) is electrically coupled to an embedded controller (EC) or a super I/O (SIO) chip. The conventional computer framework 1000 comprises a central processing unit (CPU) 10, a platform controller hub (PCH) chipset 20, an embedded controller (EC) or a super I/O (SIO) chip 30, a basic input/output system (BIOS) 40 and a universal serial bus (USB) device 50, wherein the platform controller hub (PCH) chipset 20 has a USB host interface 25.

In addition, please refer to FIG. 1B which illustrates another conventional computer framework 1200 in which a basic input/output system (BIOS) is electrically coupled to a platform controller hub (PCH) chipset. The conventional computer framework 1200 comprises a central processing unit (CPU) 12, a platform controller hub (PCH) chipset 22, an embedded controller (EC) or a super I/O (SIO) chip 32, a basic input/output system (BIOS) 42 and a universal serial bus (USB) device 52, wherein the platform controller hub (PCH) chipset 22 has a USB host interface 27.

In order to update the basic input/output system (BIOS) in the aforementioned two computer frameworks 1000, 1200, normally the basic input/output systems (BIOS) 40, 42 is updated through the basic input/output system (BIOS) or an application program of the operating system (OS) with the updating information stored in the USB device 50, 52. However, the prerequisite is that the computer must be powered on successfully; otherwise, the basic input/output systems (BIOS) 40, 42 cannot be updated.

### SUMMARY OF THE INVENTION

One objective of the present invention is to propose an apparatus for updating firmware or parameters when a failure occurs during powering on a computer.

The first aspect of the present invention is to propose an apparatus for updating firmware or parameters. The apparatus is disposed in a computer system and electrically coupled to a platform controller hub (PCH) chipset having a first USB host interface and a nonvolatile memory. The apparatus comprises: a second USB host interface; a switch element, electrically coupled to the first USB host interface, the second USB host interface and a USB device, wherein the switch element electrically couples the USB device to either the first USB host interface or the second USB host interface; and a control element, electrically coupled to the second USB host interface and the switch element, wherein when the computer system is not powered on normally, the control element controls the switch element to electrically couple the USB device to the second USB host interface, wherein the control element fetches a firmware or parameters stored in the USB device and updates the nonvolatile memory with the fetched firmware or the parameters.

The second aspect of the present invention is to propose an apparatus for updating firmware or parameters. The apparatus is disposed in a computer system and electrically coupled to a platform controller hub (PCH) chipset having a first USB host interface and a nonvolatile memory. The apparatus comprises: a second USB host interface; a switch element, electrically coupled to the first USB host interface, the second USB host interface and a USB device, wherein the switch element electrically couples the USB device to either the first USB host interface or the second USB host interface; and a control element, electrically coupled to the second USB host interface and the switch element, wherein when the control element receives a control command from the platform controller hub (PCH) chipset or an external control command from the computer system, the control element controls the switch element to electrically couple the USB device to the second USB host interface, wherein the control element fetches a firmware or parameters stored in the USB device and updates the nonvolatile memory with the fetched firmware or the parameters.

The third aspect of the present invention is to propose a computer system, which comprises: a nonvolatile memory; a USB device, storing a firmware or parameters for updating the computer system; a platform controller hub (PCH) chipset having a first USB host interface; and an apparatus for updating firmware or parameters, electrically coupled to the nonvolatile memory, the USB device and the platform controller hub (PCH) chipset, wherein the apparatus comprises: a second USB host interface; and a switch element, electrically coupled to the first USB host interface, the second USB host interface and the USB device, wherein the switch element electrically couples the USB device to either the first USB host interface or the second USB host interface; and a control element, electrically coupled to the second USB host interface and the switch element, wherein when the computer system is not powered on normally, the control element controls the switch element to electrically couple the USB device to the second USB host interface, wherein the control element fetches the firmware or parameters and updates the nonvolatile memory with the firmware or the parameters.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 A illustrates a schematic diagram of one conventional computer framework;

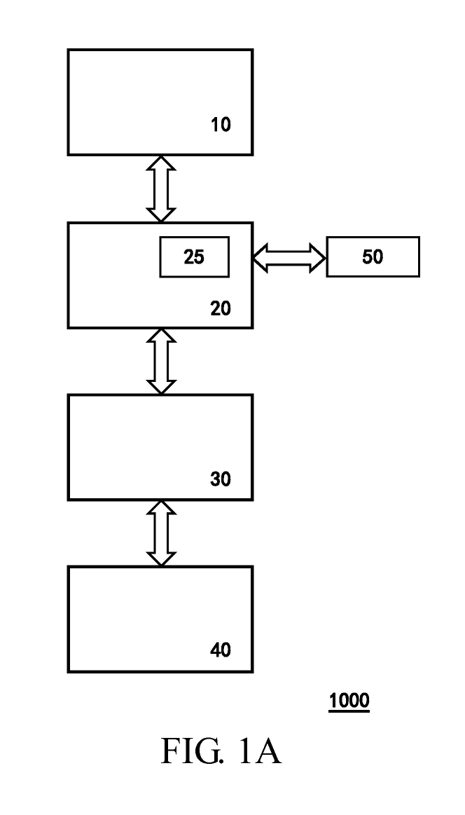

FIG. 1B illustrates a schematic diagram of another conventional computer framework;

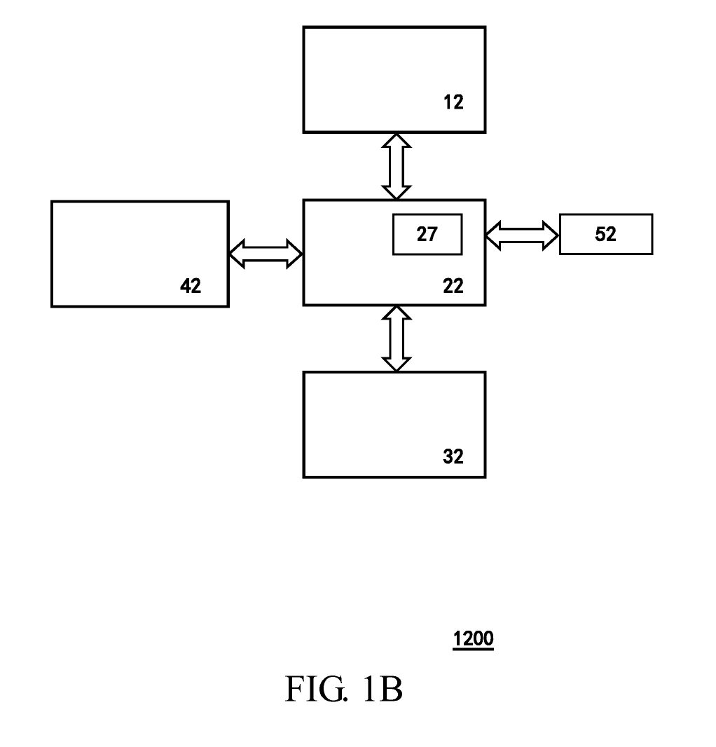

FIG. 2A illustrates a schematic diagram of a computer framework in accordance with one embodiment of the present invention;

FIG. 2B illustrates a schematic diagram of a computer framework in accordance with another embodiment of the present invention; and

FIG. 3 illustrates a schematic diagram of a computer framework in accordance with yet another embodiment of the present invention.

### DETAILED DESCRIPTION OF THE INVENTION

The detailed explanation of the present invention is described as follows. To understand the present invention more easily, the described preferred embodiments are presented for purposes of illustrations and description and they are not intended to limit the scope of the present invention. For simplicity, the same or similar code names will be given to the following the same or similar elements

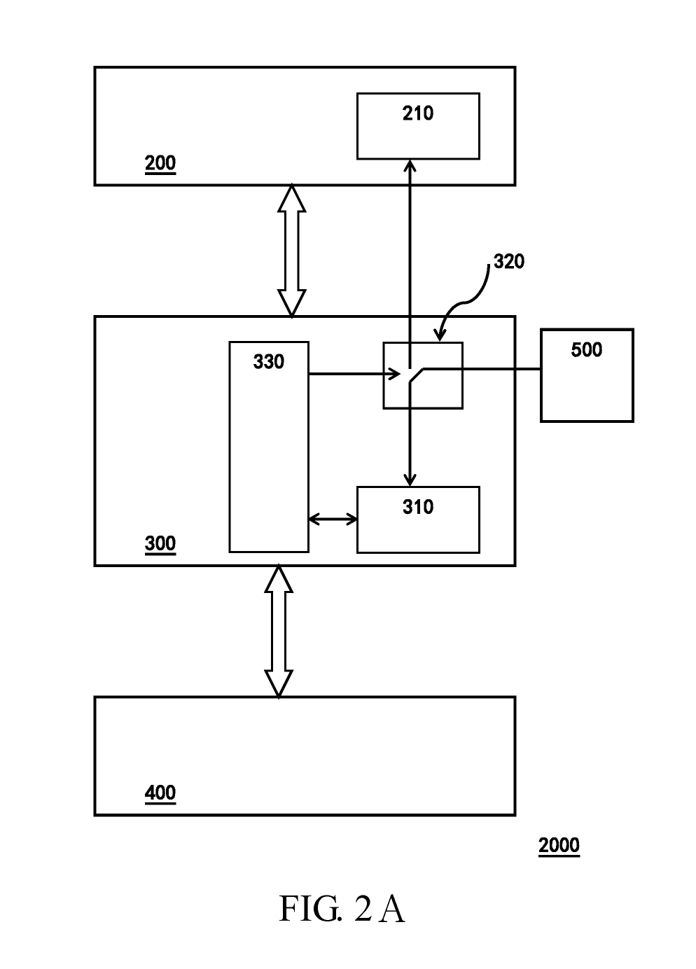

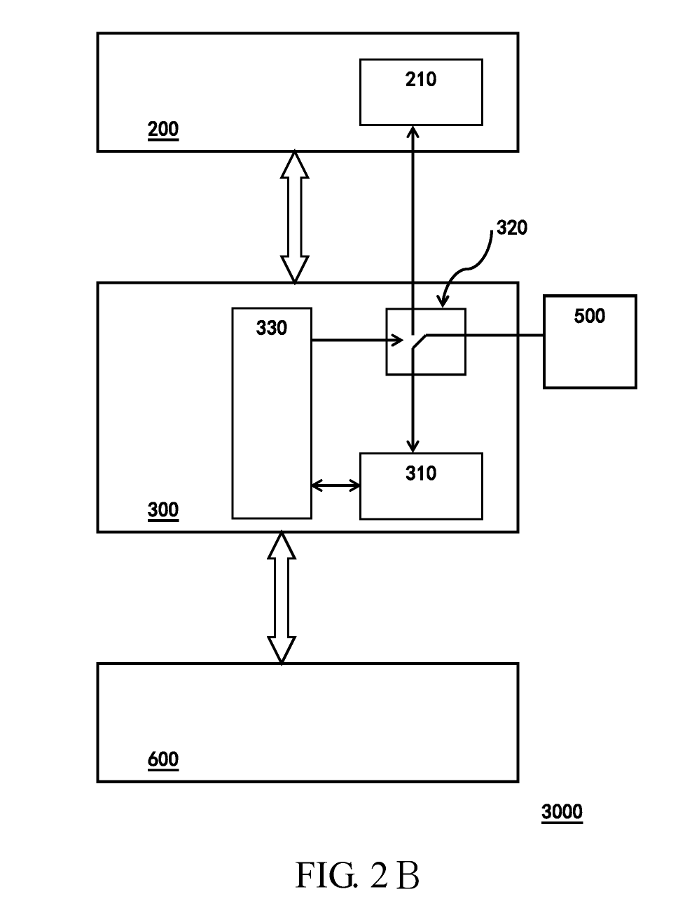

Firstly, FIG. 2A illustrates a schematic diagram of a computer system 2000 in accordance with one embodiment of the present invention. The computer system 2000 comprises a platform controller hub (PCH) chipset 200, an embedded controller (EC) or a super I/O (SIO) chip 300, a basic input/output system (BIOS) 400 and a USB device 500. This embodiment is directed to the framework in which the basic input/output system (BIOS) 400 is electrically coupled to the embedded controller (EC) or the super I/O (SIO) chip 300. Therefore, the platform controller hub (PCH) chipset 200 is electrically coupled to the embedded controller (EC) or the super I/O (SIO) chip 300, and the embedded controller (EC) or the super I/O (SIO) chip 300 is electrically coupled to the basic input/output system (BIOS) 400. The platform controller hub (PCH) chipset 200 has a first USB host interface 210. The embedded controller (EC) or the super I/O (SIO) chip 300 has a second USB host interface 310, a switch element 320 and a control element 330.

The switch element 320 electrically couples the USB device 500 to either the first USB host interface 210 or the second USB host interface 310. When the switch element 320 electrically couples the USB device 500 to the first USB host interface 210, the platform controller hub (PCH) chipset 200 can communicate with the USB device 500 while the embedded controller (EC) or the super I/O (SIO) chip 300 cannot communicate with the USB device 500. On the contrary, when the switch element 320 electrically couples the USB device 500 to the second USB host interface 310, the embedded controller (EC) or the super I/O (SIO) chip 300 can communicate with the USB device 500 while the platform controller hub (PCH) chipset 200 cannot communicate with the USB device 500.

In this embodiment, the USB device 500 stores a firmware or parameters for updating the basic input/output system (BIOS) 400. When the computer system 2000 is not powered on normally, a user can press an external key (not shown in FIG. 2A) in the computer system 2000 to trigger the switch element 320 to electrically couple the USB device 500 to the second USB host interface 310. Therefore, the embedded controller (EC) or the super I/O (SIO) chip 300 can fetch the firmware or parameters stored in the USB device 500 and execute a program to update the firmware or parameters in the basic input/output system (BIOS) 400.

FIG. 2B illustrates a schematic diagram of a computer system 3000 in accordance with another embodiment of the present invention. The computer system 3000 comprises a platform controller hub (PCH) chipset 200, an embedded controller (EC) or a super I/O (SIO) chip 300, a nonvolatile memory 600 and a USB device 500. The platform controller hub (PCH) chipset 200 has a first USB host interface 210. The embedded controller (EC) or the super I/O (SIO) chip 300 has a second USB host interface 310, a switch element 320 and a control element 330.

The switch element 320 electrically couples the USB device 500 to either the first USB host interface 210 or the second USB host interface 310. The USB device 500 stores a firmware or parameters for updating the nonvolatile memory 600. The switch element 320 can be triggered to electrically couple the USB device 500 to the second USB host interface 310 by an external control command produced by a user pressing an external key (not shown in FIG. 2B) in the computer system 3000 when the computer system 3000 is not powered on normally, or by other control commands through the platform controller hub (PCH) chipset 200 when computer system 3000 is powered on normally. At this time, the embedded controller (EC) or the super I/O (SIO) chip 300 can fetch the firmware or parameters stored in the USB device 500 and execute a program to update the firmware or parameters in the nonvolatile memory 600.

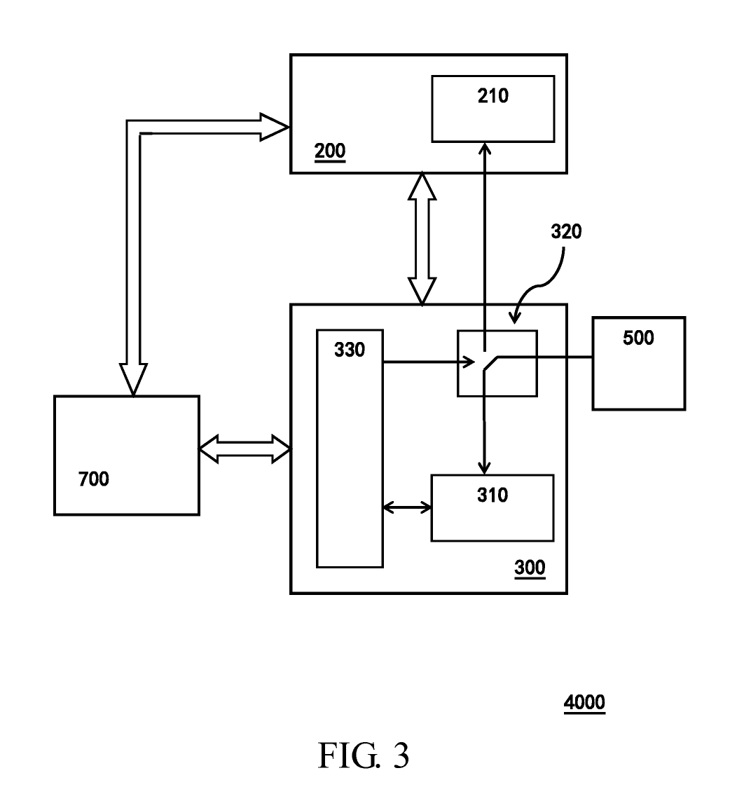

Please refer to FIG. 3 which illustrates a schematic diagram of a computer system 4000 in accordance with yet another embodiment of the present invention. The computer system 4000 comprises a platform controller hub (PCH) chipset 200, an embedded controller (EC) or a super I/O (SIO) chip 300, a nonvolatile memory 700 and a USB device 500. This embodiment is directed to the framework in which the nonvolatile memory 700 is electrically coupled to the platform controller hub (PCH) chipset 200. The platform controller hub (PCH) chipset 200 and the embedded controller (EC), or the super I/O (SIO) chip 300, are both electrically coupled to the nonvolatile memory 700. The platform controller hub (PCH) chipset 200 has a first USB host interface 210. The embedded controller (EC) or the super I/O (SIO) chip 300 has a second USB host interface 310, a switch element 320 and a control element 330.

The switch element 320 electrically couples the USB device 500 to either the first USB host interface 210 or the second USB host interface 310. When the switch element 320 electrically couples the USB device 500 to the first USB host interface 210, the platform controller hub (PCH) chipset 200 can communicate with the USB device 500 while the embedded controller (EC) or the super I/O (SIO) chip 300 cannot communicate with the USB device 500. On the contrary, when the switch element 320 electrically couples the USB device 500 to the second USB host interface 310, the embedded controller (EC) or the super I/O (SIO) chip 300 can communicate with the USB device 500 while the platform controller hub (PCH) chipset 200 cannot communicate with the USB device 500.

In this embodiment, the USB device 500 stores a firmware or parameters for updating the nonvolatile memory 700. The switch element 320 can be triggered to electrically couple the USB device 500 to the second USB host interface 310 by an external control command produced by a user pressing an external key (not shown in FIG. 3) in the computer system 4000, or by other control commands produced by the platform controller hub (PCH) chipset 200. Therefore, the embedded controller (EC) or the super I/O (SIO) chip 300 can fetch the firmware or parameters stored in the USB device 500 and execute a program to update the firmware or parameters in the nonvolatile memory 700.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for updating firmware or parameters, wherein the apparatus is disposed in a computer system and electrically coupled to a platform controller hub (PCH) chipset having a first USB host interface and a nonvolatile memory, the apparatus comprising:
a second USB host interface;
a switch element, electrically coupled to the first USB host interface, the second USB host interface and a USB device, wherein the switch element electrically couples the USB device to either the first USB host interface or the second USB host interface; and
a control element, electrically coupled to the second USB host interface and the switch element;
wherein when the computer system is not powered on normally, the control element controls the switch element to electrically couple the USB device to the second USB host interface, wherein the control element fetches a firmware or parameters stored in the USB device and updates the nonvolatile memory with the firmware or the parameters.

2. The apparatus for updating firmware or parameters according to claim 1, wherein the nonvolatile memory contains a basic input/output system (BIOS).

3. A computer system, comprising:
a nonvolatile memory;
a USB device, storing a firmware or parameters for updating the computer system;
a platform controller hub (PCH) chipset, having a first USB host interface; and
an apparatus for updating firmware or parameters, electrically coupled to the nonvolatile memory, the USB device and the platform controller hub (PCH) chipset, wherein the apparatus comprises:
a second USB host interface;
a switch element, electrically coupled to the first USB host interface, the second USB host interface and the USB device, wherein the switch element electrically couples the USB device to either the first USB host interface or the second USB host interface; and
a control element, electrically coupled to the second USB host interface and the switch element;
wherein when the computer system is not powered on normally, the control element controls the switch element to electrically couple the USB device to the second USB host interface, wherein the control element fetches the firmware or parameters and updates the nonvolatile memory with the firmware or the parameters.

4. The computer system according to claim 3, wherein the nonvolatile memory contains a basic input/output system (BIOS).

5. The computer system according to claim 3, wherein the apparatus comprises an embedded controller (EC).

6. The computer system according to claim 3, wherein the apparatus is disposed in a super I/O (SIO) chip.

7. An apparatus for updating firmware or parameters, wherein the apparatus is disposed in a computer system and electrically coupled to a platform controller hub (PCH) chipset having a first USB host interface and a nonvolatile memory, the apparatus comprising:
a second USB host interface;
a switch element, electrically coupled to the first USB host interface, the second USB host interface and a USB device, wherein the switch element electrically couples the USB device to either the first USB host interface or the second USB host interface; and
a control element, electrically coupled to the second USB host interface and the switch element;
wherein when the control element receives a control command from the platform controller hub (PCH) chipset or an external control command from the computer system, the control element controls the switch element to electrically couple the USB device to the second USB host interface, wherein the control element fetches a firmware or parameters stored in the USB device and updates the nonvolatile memory with the firmware or the parameters.

8. The apparatus for updating firmware or parameters according to claim 7, wherein the nonvolatile memory contains a basic input/output system (BIOS).

9. A computer system, comprising:
a nonvolatile memory;
a USB device, storing a firmware or parameters updating the computer system;
a platform controller hub (PCH) chipset, having a first USB host interface; and
an apparatus for updating firmware or parameters, electrically coupled to the nonvolatile memory, the USB device and the platform controller hub (PCH) chipset, wherein the apparatus comprises:
a second USB host interface;
a switch element, electrically coupled to the first USB host interface, the second USB host interface and the USB device, wherein the switch element electrically couples the USB device to either the first USB host interface or the second USB host interface; and
a control element, electrically coupled to the second USB host interface and the switch element;
wherein when the control element receives a control command from the platform controller hub (PCH) chipset or an external control command from the computer system, the control element controls the switch element to electrically couple the USB device to the second USB host interface, wherein the control element fetches the firmware or parameters and updates the nonvolatile memory with the firmware or the parameters.

10. The computer system according to claim 9, wherein the nonvolatile memory contains a basic input/output system (BIOS).

11. The computer system according to claim 9, wherein the apparatus for updating firmware or parameters comprises an embedded controller (EC).

12. The computer system according to claim 9, wherein the apparatus for updating firmware or parameters is disposed in a super I/O (SIO) chip.
